(19) United States
(12) Patent Application Publication
(10) Pub. No.: US 2015/0098218 A1
(43) Pub. Date: Apr. 9, 2015

(54) LIGHT EMITTING MODULE, AND ILLUMINATION LIGHT SOURCE AND LIGHTING APPARATUS EACH USING THE LIGHT EMITTING MODULE

(71) Applicant: PANASONIC CORPORATION, Osaka (JP)

(72) Inventors: Makoto KAI, Kyoto (JP); Takaari UEMOTO, Osaka (JP); Satoshi SHIDA, Osaka (JP)

(73) Assignee: PANASONIC CORPORATION, Osaka (JP)

(21) Appl. No.: 14/499,940

(22) Filed: Sep. 29, 2014

(30) Foreign Application Priority Data
Oct. 3, 2013 (JP) 2013-208641

(51) Int. Cl. F21K 99/00; F21V 19/00

(52) U.S. Cl. CPC F21K 9/1355; F21K 9/50; F21V 19/002
USPC 362/231

(57) ABSTRACT

A light emitting module includes: a substrate; first light emitting elements arranged circularly on the substrate and having a first light distribution angle (a narrow light distribution angle); and second light emitting elements arranged circularly to surround the plurality of first light emitting elements on the substrate, and having a second light distribution angle (a wide light distribution angle) different from the first light distribution angle.

### BACKGROUND OF THE INVENTION

1. Field of the Invention

The present disclosure relates to a light emitting module, and an illumination light source and a lighting apparatus each including the light emitting module, and relates particularly to a light emitting module having Light Emitting Diodes (LED).

2. Description of the Related Art

Light Emitting Diodes (LEDs) are used as light sources in a variety of products due to their high efficiency and long lifespan. Among these light sources, lamps with LEDs (LED lamps) are increasingly being used as illumination light sources in place of fluorescent lamps, incandescent bulbs, etc.

Examples of LED lamps include bulb-shaped LED lamps (LED bulbs) for use as substitutes for fluorescent and incandescent bulbs, straight-tube-shaped LED lamps for use as substitutes for straight-tube-shaped fluorescent lamps. For example, Japanese Unexamined Patent Application Publication No. 2006-313717 discloses a bulb-shaped LED lamp as a related technique. In addition, Japanese Unexamined Patent Application Publication No. 2009-043447 discloses a straight-tube-shaped LED lamp as a related technique.

An LED module that is a light source (light emitting device) is arranged in an LED lamp. An LED module includes, for example, a circuit substrate and LEDs mounted on the circuit substrate.

### SUMMARY OF THE INVENTION

A light emitting module includes a substrate, a plurality of first light emitting elements, and a plurality of second light emitting elements. The plurality of first light emitting elements are arranged circularly on the substrate, and each emit first spectrum light at a first light distribution angle. The plurality of second light emitting elements are arranged circularly on the substrate to surround the plurality of first light emitting elements, and each emit second spectrum light at a second light distribution angle. The first light distribution angle and the second light distribution angle are different from each other.

### BRIEF DESCRIPTION OF DRAWINGS

FIG. 1 is a partially cutaway perspective view of an illumination light source according to a first embodiment;

FIG. 2 is a top view of a light emitting module according to the first embodiment;

FIG. 3 is a cross sectional view of the light emitting module taken at line 3-3 in FIG. 2;

FIG. 4 is a schematic cross sectional view of a lighting apparatus according to the first embodiment;

FIG. 5 is a top view of a light emitting module according to a second embodiment;

FIG. 6 is a cross sectional view of the light emitting module taken at line 6-6 in FIG. 5;

FIG. 7 is a cross sectional view of a light emitting module according to a third embodiment;

FIG. 8 is a perspective view of an optical element of the light emitting module according to the third embodiment;

FIG. 9 is a cross sectional view of a light emitting module according to a fourth embodiment;

FIG. 10 is a cross sectional view of a light emitting module according to a fifth embodiment; and

FIG. 11 is a perspective view of an optical element of the light emitting module according to the fifth embodiment.

### DETAILED DESCRIPTION OF THE PREFERRED EMBODIMENTS

Before the descriptions of embodiments, a problem with an illumination light source in the related art will be described. In an LED lamp in the related art, an LED module including a substrate and a plurality of LEDs mounted on the substrate is used. These LEDs are arranged circularly or linearly. Furthermore, in order to adjust light distribution characteristics of these LEDs collectively, an optical element such as a circular or linear diffusion element is used.

In this case, light emitted from an LED lamp has a single light distribution characteristic. For example, the single light distribution characteristic is either a wide angle light distribution characteristic or a narrow angle light distribution characteristic. Accordingly, in order to obtain a light distribution characteristic suitable for an application, there is a need to use an LED lamp for the application.

Hereinafter, a light emitting module and an illumination light source according to each of embodiments are described with reference to the Drawings. It is to be noted that each of the embodiments described below is a preferred example in the present disclosure. Accordingly, the numerical values, shapes, materials, constituent elements, the arrangement and connection of the constituent elements, processes (steps), and order of the processes are mere examples.

It should be noted that the respective Drawings are schematic diagrams and are not necessarily precise illustrations. Additionally, components that have substantially the same shapes are assigned with the same reference numerals in the respective Drawings, and overlapping explanations for the same shapes are omitted or simplified.

In the embodiments below, LED modules with LEDs as light emitting elements are described as examples of light emitting modules, and bulb-shaped LED lamps (LED bulbs) are described as examples of illumination light sources.

### First Embodiment

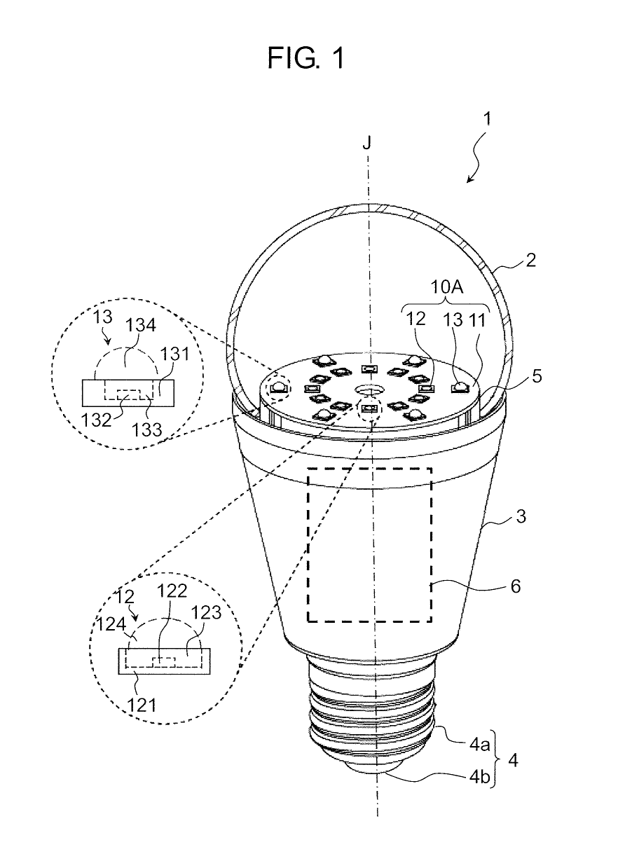

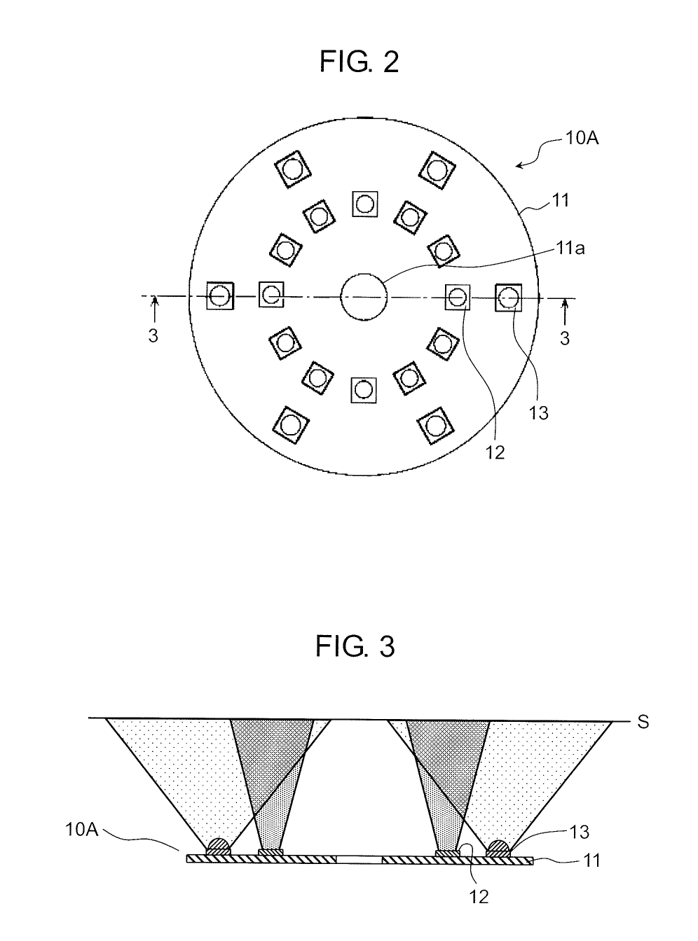

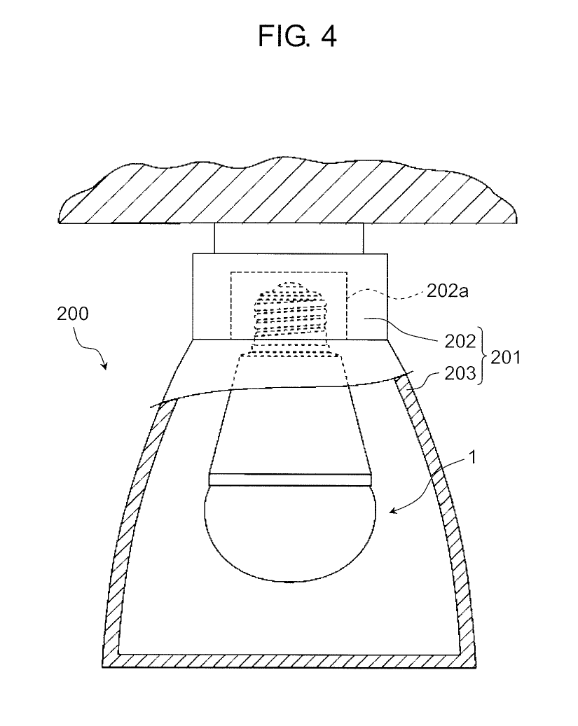

With reference to FIG. 1 to FIG. 4, light emitting module 10A, illumination light source 1, and lighting apparatus 200 according to a first embodiment are described. FIG. 1 is a partially cutaway perspective view of illumination light source 1. FIG. 2 is a top view of light emitting module 10A. FIG. 3 is a cross sectional view taken at line 3-3 in FIG. 2. FIG. 4 is a schematic cross sectional view of lighting apparatus 200.

A straight line passing through top part 2a of globe 2 of illumination light source 1 and a top part of base 4 of illumination light source 1 is assumed to be lamp axis J. Lamp axis J is a rotation axis in the case where illumination light source 1 is attached to socket 202a of lighting apparatus 200 (FIG. 4), and matches a rotation axis of base 4. In addition, lamp axis J also matches a rotation axis (globe axis) of globe 2.

Illumination light source 1 is a bulb-shaped LED lamp, and includes light emitting module 10A, globe 2, housing 3, base 4, pedestal 5, and circuit unit 6. Light emitting module 10A is mounted on pedestal 5. Circuit unit 6 is housed inside housing 3, and supplies predetermined electric power to light emitting module 10A. Housing 3 is a tube-shaped member including a first opening and a second opening. Globe 2 is hollow and arranged to cover the first opening of housing 3. Base 4 is arranged at the second opening of housing 3. Base 4 is electrically connected to circuit unit 6.

Hereinafter, each of components of illumination light source 1 is described with reference to FIG. 1 and FIG. 2.

### [Light Emitting Module]

Light emitting module 10A includes substrate 11, a plurality of first light emitting elements 12, and a plurality of second light emitting elements 13. The plurality of first light emitting elements 12 are arranged circularly on substrate 11, and each emit first spectrum light at a first light distribution angle. The plurality of second light emitting elements 13 are arranged circularly on substrate 11 to cover the plurality of first light emitting elements 12, and each emit second spectrum light at a second light distribution angle. The first light distribution angle and the second light distribution angle are different from each other.

Substrate 11 is, for example, an approximately circular substrate having approximately circular through hole 11a at the center of substrate 11. The center of through hole 11a matches lamp axis J. Through hole 11a is passed through by a line for supplying electric current from circuit unit 6 arranged inside housing 3 to each of first light emitting elements 12 and second light emitting elements 13. Examples which can be employed as substrate 11 include a metal substrate coated with an insulating film obtained by coating an insulating film on a material of a metal such as aluminum, a ceramics substrate made of alumina or the like, and a resin substrate made of epoxy resin or the like. A wiring pattern (not shown in the Drawings) electrically connected to first light emitting elements 12 and second light emitting elements 13 is formed on the front surface of substrate 11.

Each of first light emitting elements 12 and second light emitting elements 13 includes an LED. The LED is a Surface Mount Device (SMD). The plurality of first light emitting elements 12 are arranged concentrically to surround through hole 11a. The plurality of second light emitting elements 13 are arranged concentrically to surround through hole 11a and the plurality of first light emitting elements 12. First light emitting elements 12 and second light emitting elements 13 are mounted, on substrate 11, to have an orientation at which a main emission direction is opposite to a direction of substrate 11.

As illustrated in FIG. 3, first light emitting elements 12 emit the first spectrum light of the first light distribution angle, and second light emitting elements 13 emit the second spectrum light of the second light distribution angle. The first light distribution angle is smaller than the second light distribution angle. The first light distribution angle is a narrow angle, and is for example an angle of 15 degrees or larger and smaller than 90 degrees. The second light distribution angle is a wide angle, and is for example an angle of 90 degrees to 120 degrees inclusive.

As illustrated in FIG. 1, each of first light emitting elements 12 includes container 121, LED chip 122 mounted inside container 121, and sealing member 123 covering LED chip 122. First light emitting element 12 may further include lens 124. Lens 124 can be set appropriately depending on a light distribution angle.

For example, a red LED chip that emits red light may be used as LED chip 122. The red LED chip is, for example, a semiconductor light emitting element made of an AlGaInP material, and emits light having a center wavelength ranging from 630 nm to 660 nm inclusive.

For example, a blue LED chip that emits blue light may be used as LED chip 122. The blue LED chip is, for example, a semiconductor light emitting element made of an InGaN material, and emits light having a center wavelength ranging from 440 nm to 470 nm inclusive. Sealing member 123 may include, as necessary, phosphor particles (not shown in the Drawings) that convert a wavelength of light from LED chip 122. For example, yellow phosphor particles of yttrium aluminum garnet (YAG) may be used as phosphor particles. When LED chip 122 is a blue LED chip, first light emitting element 12 can emit white light. For example, a light transmitting material such as silicon resin may be used as sealing member 123. Sealing member 123 may be made from an organic material such as a fluorocarbon polymer, as well as a non-organic material such as low-melting glass or sol-gel glass, instead of being made from silicon resin.

The material, shape, etc. of container 121 are not particularly limited. For example, ceramics having a high reflectivity or a resin having a high transmittance of visible light may be used as a material for container 121. In the former case, losses stemming from container 121 can be reduced. In the latter case, light can be extracted also from side surfaces of container 121.

For example, lens 124 can be made of silicon resin. Alternatively, lens 124 can be made of a light transmitting material other than silicon resin

For example, a semiconductor laser, an organic Electro Luminescence (EL) element or inorganic EL element may be used as first light emitting element 12. The above descriptions for first light emitting elements 12 are reused as descriptions for second light emitting elements 13 by replacing some of the terms as indicated below. First light emitting elements 12, container 121, LED chips 122, sealing member 123, and lens 124 are replaced with second light emitting elements 13, container 131, LED chips 132, sealing member 133, and lens 134, respectively.

In light emitting module 10A, first light emitting elements 12 emit red light that is first spectrum light, and second light emitting elements 13 emit white light that is second spectrum light. In addition, first light emitting elements 12 emit light of a light distribution angle smaller than the light distribution angle of second light emitting elements 13.

### [Pedestal]

Pedestal 5 is a module attaching member for mounting light emitting module 10A. Light emitting module 10A is arranged on a mounting surface of pedestal 5, and is fixed on pedestal 5 by mounting hardware, a screw, bonding, or the like.

Pedestal 5 is an approximately cylindrical body in which a through hole (not shown in the Drawings) is formed. Pedestal 5 has a center axis matching lamp axis J. Light emitting module 10A is mounted on the mounting surface of pedestal 5. The position of the through hole in pedestal 5 matches the position of through hole 11a of light emitting module 10A. The through hole in pedestal 5 is passed through by a cable (not shown in the Drawings) for supplying electric current from circuit unit 6 arranged inside housing 3 to light emitting module 10A.

Pedestal 5 is for example made of a metal material. Al, Cu, Fe, an alloy, or the like may be used as a metal material. Such a metal material has an excellent heat transfer rate, and can efficiently disperse heat generated in light emitting module 10A to outside illumination light source 1.

Pedestal 5 is arranged at an end part of one of openings of housing 3 that is a tubular member.

### [Housing]

Housing 3 is arranged between globe 2 and base 4. Housing 3 is a tube-shaped member, and has a first opening at which globe 2 is attached and a second opening at which base 4 is attached. In housing 3, the first opening at which globe 2 is attached is larger than the second opening at which base 4 is attached. In other words, housing 3 has an approximately truncated cone shape. Circuit unit 6 is housed inside housing 3. A first opening of housing 3 houses pedestal 5 and an opening end part of globe 2.For example, a resin material such as polybutylene terephthalate (PBT) or a metal material such as aluminum may be used as housing 3.

### [Globe]

Globe 2 is a hemispherical cover for passing through light emitted from light emitting module 10A to outside the lamp. In addition, light emitting module 10A is covered by globe 2. Light from light emitting module 10A incident onto an inner surface of globe 2 passes through globe 2 and is extracted to outside globe 2.

Globe 2 is a globular hollow body having an opening. An end part of the opening is sandwiched between a side part of pedestal 5 and an end part of a first opening of housing 3. Globe 2 is attached to at least pedestal 5 or housing 3 by bonding, press fitting, or the like.

In addition, a light diffusion process for dispersing light emitted from light emitting module 10A may be performed on globe 2. For example, by forming a light diffusion film (light diffusion layer) on an inner surface or an outer surface of globe 2, it is possible to provide globe 2 with a light diffusing function. More specifically, such a light diffusion film can be formed by applying a resin, a pigment, or the like containing a light diffusing substance such as silica, calcium carbonate, or the like onto the entire inner or outer surface of globe 2. Alternatively, for example, it is possible to provide globe 2 with the light diffusing function by forming a plurality of micro protrusions or a plurality of micro recesses on globe 2 made of resin. In addition, it is also possible to provide globe 2 with a light diffusing function by providing a wrinkle pattern (performing surface texturing).

In this way, it is possible to diffuse light which is emitted from light emitting module 10A and enters globe 2 by providing globe 2 with the light diffusing function, which makes it possible to widen a light distribution angle of illumination light source 1.

It is to be noted here that globe 2 is not limited to a globe having a hemispherical shape. The shape of globe 2 may be a spheroid or an oblate spheroid. For example, it is possible to use a globe corresponding to a globe of a general electric bulb.

In addition, globe 2 may be made from a synthetic resin such as polycarbonate or a glass material.

### [Base]

Base 4 receives, from outside of illumination light source 1, electric power for causing light emitting module 10A to emit light. Base 4 includes shell part 4a having an outer peripheral surface including male screw threads, and eyelet part 4b attached to shell part 4a via an insulating part. Base 4 is screwed into socket 202a of lighting fixture 200, and receives electric power. In addition, the electric power received by base 4 is input to circuit unit 6 arranged inside housing 3 through a lead wire (not shown in the Drawings).

The type of base 4 is not particularly limited to a certain type. Tn illumination light source 1, a threaded Edison type base is used. Base 4 may be a plug-in base rather than a threaded base.

### [Circuit Unit]

Circuit unit 6 is a lighting circuit for causing light emitting module 10A to emit light (turning on light emitting module 10A), and supplies predetermined electric power to light emitting module 10A. Circuit unit 6 converts alternating current power supplied from base 4 through a pair of lead wires (not shown in the Drawings) into direct current power, and supplies the direct current power to light emitting module 10A through the lead wires.

Circuit unit 6 includes a circuit substrate (not shown in the Drawings) and a plurality of electronic components (not shown in the Drawings) for turning on light emitting module 10A. Each of the electronic components is mounted on the circuit substrate.

Next, light distribution characteristics of illumination light source 1 are described with reference to FIG. 3.

FIG. 3 is a cross sectional view of light emitting module 10A taken at line 3-3 in FIG. 2, and illustrates light distribution characteristics of first light emitting elements 12 and second light emitting elements 13. The first light distribution angle is smaller than the second light distribution angle. For this reason, as illustrated in FIG. 3, in light irradiation surface S, light emitted from first light emitting elements 12 is focused onto a narrow area, and light emitted from second light emitting elements 13 is irradiated throughout a wide area. First light emitting elements 12 can irradiate light onto a predetermined target in a focused manner. Second light emitting elements 13 can widely irradiate the periphery of light emitting module 10A.

In addition, in light emitting module 10A, a first spectrum emitted from first light emitting elements 12 and a second spectrum emitted from second light emitting elements 13 may be different from each other. In this way, for example, red light and white light may be used as the first spectrum light and the second spectrum light, respectively. The first spectrum light that is the red light can be irradiated, in a focused manner, onto a predetermined target such as a plant, as an application for accelerating growth of the plant. The second spectrum light that is the white light can be irradiated onto a wide area for a worker around the plant.

As described above, light emitting module 10A includes substrate 11, first light emitting elements 12 arranged on substrate 11 and having a small light distribution angle, and second light emitting elements 13 arranged circularly on substrate 11 to surround first light emitting elements 12 and having a light distribution angle larger than the light distribution angle of first light emitting elements 12.

In this way, it is possible to irradiate the light emitted from first light emitting elements 12 onto the irradiation target in a focused manner, and to irradiate the light emitted from second light emitting elements 13 onto the wide area.

It is to be noted that, in illumination light source 1, globe 2 may have a transparent part that is not subjected to a light dispersion process. It is possible to irradiate light emitted from first light emitting elements 12 onto the irradiation target in a focused manner by causing first light emitting elements 12 to emit light through the transparent part of globe 2 without dispersion of the light.

The first spectrum light and the second spectrum light are not limited to the above examples. Any of first light emitting elements 12 and second light emitting elements 13 may have an arbitrary luminescence spectrum.

### [Lighting Apparatus]

Lighting apparatus 200 according to the first embodiment is described with reference to FIG. 4.

Lighting apparatus 200 includes lighting fixture 201 and illumination light source 1, and is, for example, used by being attached to the ceiling in a room. Lighting fixture 201 includes socket 202a. Illumination light source 1 is attached to socket 202a. In other words, illumination light source 1 is attached to lighting fixture 201 through socket 202a. Illumination light source 1 is fixed to lighting fixture 201 by screwing base 4 into socket 202a. Alternating current power is supplied from outside to illumination light source 1 through socket 202a. Illumination light source 1 can be turned on or off by lighting apparatus 200. It is to be noted that at least one of light emitting modules 10B to 10E to be described later may be used in illumination light source 1.

### Second Embodiment

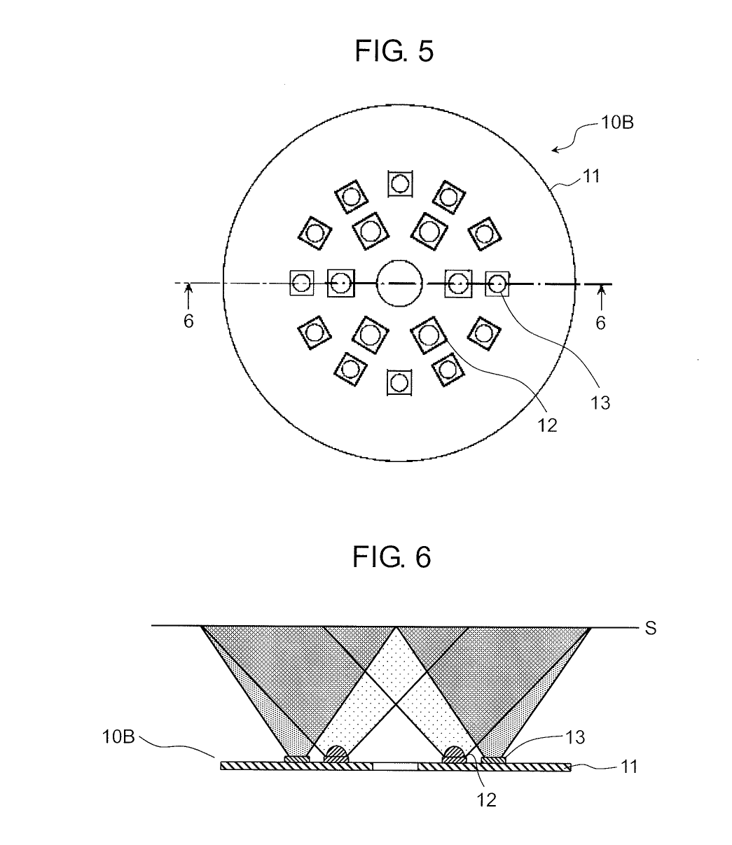

Next, a structure of light emitting module 10B according to a second embodiment is described with reference to FIGS. 5 and 6. FIG. 5 is a top view of light emitting module 10B. FIG. 6 is a cross sectional view of light emitting module 10B taken at line 6-6, and illustrates light distribution characteristics.

Light emitting module 10B is different from light emitting module 10.A in the light distribution angle of first light emitting elements 12 and the light distribution angle of second light emitting elements 13. Light emitting module 10B includes substrate 11, first light emitting elements 12, and second light emitting elements 13. First light emitting elements 12 are arranged circularly on substrate 11, and each emit light at a first light distribution angle. Second light emitting elements 13 are arranged circularly on substrate 11 to surround first light emitting elements 12, and each emit light at a second light distribution angle. The first light distribution angle is larger than the second light distribution angle. The first light distribution angle is a wide angle, and is for example an angle ranging from 90 degrees to 120 degrees inclusive. The second light distribution angle is a narrow angle, and is for example an angle of 15 degrees or larger and smaller than 90 degrees.

With this structure, it is possible to achieve a light distribution characteristic that reduces uneven irradiation throughout a particular area of particular light irradiation surface S.

First spectrum light emitted from first light emitting elements 12 and second spectrum light emitted from second light emitting elements 13 may be different from each other. In other words, it is possible to reduce not only uneven irradiation but also uneven color in light irradiation surface S.

### Third Embodiment

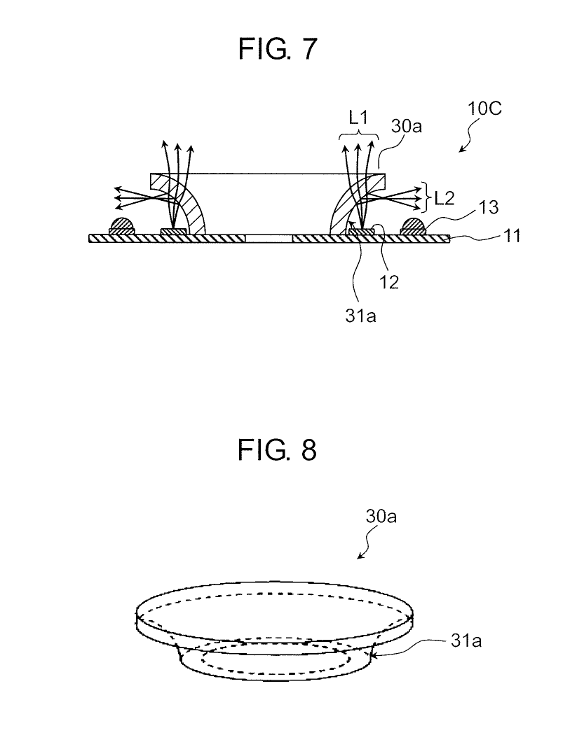

Next, a structure of light emitting module 10C according to a third embodiment is described with reference to FIGS. 7 and 8. FIG. 7 is a cross sectional view in a plane that passes through a lamp axis of light emitting module 10C. FIG. 8 is a perspective view of optical element 30a. Light emitting module 10C includes substrate 11, a plurality of first light emitting elements 12, a plurality of second light emitting elements 13, and optical element 30a. Optical element 30a is arranged on substrate 11 to surround the center of substrate 11. The plurality of first light emitting elements 12 are arranged circularly on substrate 11 to surround optical element 30a, and each emit first spectrum light at a first light distribution angle. In other words, optical element 30a is surrounded by the plurality of first light emitting elements 12. The plurality of second light emitting elements 13 are arranged circularly on substrate 11 to surround the plurality of first light emitting elements 12, and each emit second spectrum light at a second light distribution angle.

The first light distribution angle is smaller than the second light distribution angle. The first light distribution angle is a narrow angle, and is for example an angle of 15 degrees or larger and smaller than 90 degrees. The second light distribution angle is a wide angle, and is for example an angle ranging from 90 degrees to 120 degrees inclusive.

Light emitting module 10C is different from light emitting module 10A, in that optical element 30a is arranged on at least one of an optical path of light emitted from first light emitting elements 12 or an optical path of light emitted from second light emitting elements 13. In this embodiment, optical element 30a is arranged on the optical path of light emitted from first light emitting elements 12, and can change a light distribution angle of the emitted light by partly reflecting or refracting the emitted light.

Optical element 30a is made of a light transmitting material. For example, a resin material such as polycarbonate, glass, and ceramics may be used as a light transmitting material. It is to be noted that outer side surface 31a of optical element 30a may be subjected to mirror surface treatment. For example, as for a method for performing mirror surface treatment on outer side surface 31a, it is possible to form a reflection film such as a metal thin film and a dielectric multilayer film, according to a method such as thermal vapor deposition, electron beam vapor deposition, a sputtering method, and plating.

Optical element 30a is, for example, approximately cylindrical, and has openings at both ends. Both of the outer and inner diameters of optical element 30a become gradually narrower from the opening at one end to the other opening at the other end. Optical element 30a is arranged at a position further inward than first light emitting elements 12 arranged circularly on substrate 11, such that a narrower one of the openings of optical element 30a faces substrate 11. Optical element 30a is arranged such that the axis of a cylindrical body of optical element 30a is positioned to match lamp axis J (see FIG. 1).

Outer side surface 31a of optical element 30a is a surface that is recess curved with a predetermined curvature toward the axis of the cylindrical body in a cross section that passes through the axis of the cylindrical body of optical element 30a. Optical element 30a is arranged on an optical path of light emitted from first light emitting elements 12. Outer side surface 31a of optical element 30a covers first light emitting elements 12 but does not cover second light emitting elements 13. The main light emission direction of first light emitting elements 12 is directed toward outer side surface 31a. Light emitted from first light emitting elements 12 is incident onto outer side surface 31a.

As illustrated in FIG. 7, light emitted from first light emitting elements 12 diverges to transmitted light L1 that passes through outer side surface 31a of optical element 30a and reflected light L2 that is reflected by outer side surface 31a. Transparent light L1 proceeds in a direction opposite to substrate 11, and reflected light L2 proceeds in a direction opposite to lamp axis J, that is, in an outer peripheral direction of light emitting module 10C. In other words, the light distribution angle of light emitted from first light emitting elements 12 is widened by optical element 30a.

With this structure, (i) light emitted from first light emitting elements 12 and having a light distribution angle widened by optical element 30a and (ii) light emitted from second light emitting elements 13 at a wide light distribution angle are superimposed with each other. As a result, uneven irradiation is reduced.

Furthermore, in light emitting module 10C, optical element 30a covers only first light emitting elements 12 and does not cover second light emitting elements 13, and thus does not substantially affect light emitted from second light emitting elements 13. In this way, it is possible to reduce decrease in light extraction efficiency of light emitting module 10C. This is because diffusion and absorption of light emitted from second light emitting elements 13 by optical element 30a can be reduced.

In addition, in light emitting module 10C, first light emitting elements 12 are arranged in a narrow area around the center of substrate 11. For this reason, it is possible to reduce the size of optical element 30a.

Both of reflectivity and transmittance of outer side surface 31a of optical element 30a are, for example, 50%. The reflectivity and transmittance of optical element 30a can be arbitrarily selected. In order to reduce uneven irradiation and achieve a wide light distribution characteristic, it is preferable that the reflectivity and the transmittance of optical element 30a be approximately the same. For example, it is preferable that each of the reflectivity and the transmittance range from 40% to 60% inclusive.

The reflectivity and the transmittance of optical element 30a do not always need to be even throughout the outer side surface 31a. The reflectivity and the transmittance may vary depending on the position of outer side surface 31a. For example, when the amount of reflected light toward a direction of substrate 11 is decreased and the amount of reflected light toward the outer peripheral direction of substrate 11 is increased, the reflectivity of outer side surface 31a closer to the opening having a larger outer diameter may be increased, and the reflectivity of outer side surface 31a closer to the opening having a smaller outer diameter may be decreased. Alternatively, when the amount of reflected light toward a direction of substrate 11 is increased and the amount of reflected light toward the outer peripheral direction of substrate 11 is decreased, the reflectivity of outer side surface 31a closer to the opening having a larger outer diameter may be decreased, and the reflectivity of outer side surface 31a closer to the opening having a smaller outer diameter may be increased.

In addition, either first spectrum light emitted from first light emitting elements 12 or second spectrum light emitted from second light emitting elements 13 can be arbitrarily selected. For example, LEDs which emit white light that is first spectrum light can be used as first light emitting elements 12 that emit wide angle light, and LEDs which emit red light that is second spectrum light can be used as second light emitting elements 13 that emit narrow angle light. For example, red light can be used to accelerate growth of a plant. The light distribution angle of white light emitted from first light emitting elements 12 is widened by optical element 30a. For this reason, the white light can be used as illumination light for a worker around the plant.

### Fourth Embodiment

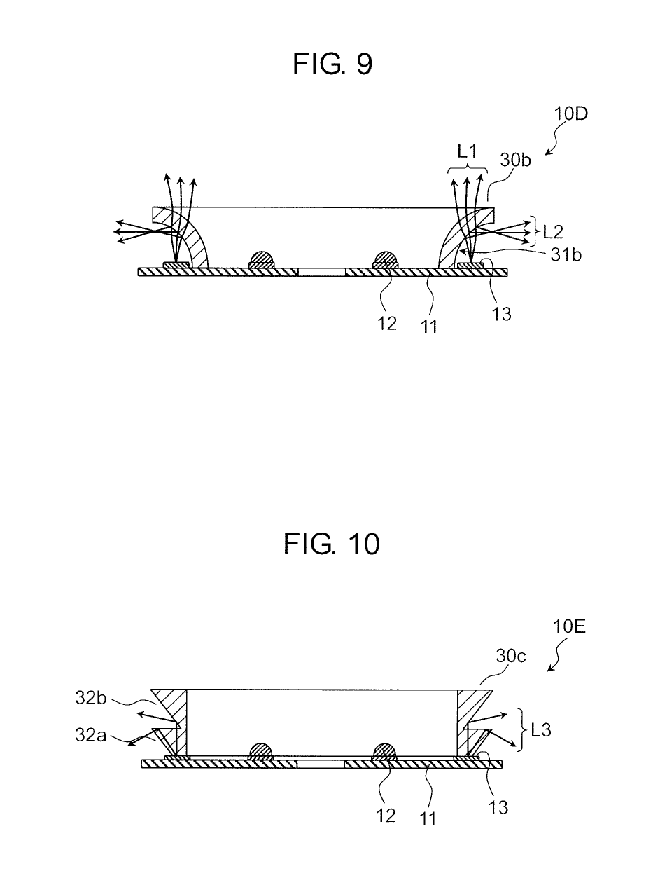

Next, a structure of light emitting module 10D according to a fourth embodiment is described with reference to FIG. 9.

FIG. 9 is a cross sectional view in a plane that passes through lamp axis J (see FIG. 1) of light emitting module 10D. Light emitting module 10D includes substrate 11, a plurality of first light emitting elements 12, a plurality of second light emitting elements 13, and optical element 30b. The plurality of first light emitting elements 12 are arranged circularly on substrate 11 to surround the center of substrate 11, and each emit first spectrum light at a first light distribution angle. Optical element 30b is arranged on substrate 11 to surround the plurality of first light emitting elements 12. The plurality of second light emitting elements 13 are arranged circularly on substrate 11 to surround optical element 30b, and each emit second spectrum light at a second light distribution angle.

The first light distribution angle is larger than the second light distribution angle. The first light distribution angle is a wide angle, and is for example an angle ranging from 90 degrees to 120 degrees inclusive. The second light distribution angle is a narrow angle, and is for example an angle of 15 degrees or larger and smaller than 90 degrees.

Light emitting module 10D is different from light emitting module 10B in having optical element 30b arranged between first light emitting elements 12 arranged circularly and second light emitting elements 13 arranged circularly.

Optical element 30b is, for example, approximately cylindrical, and has openings at both ends, similarly to optical element 30a. Both of the outer and inner diameters of optical element 30b become gradually narrower from the opening at one of the ends to the other opening at the other end. Optical element 30b is arranged, on substrate 11, at a position between first light emitting elements 12 arranged circularly and second light emitting elements 13 arranged circularly, such that a narrower one of the openings of optical element 30b faces substrate 11. The axis of a cylindrical body of optical element 30b is positioned to match lamp axis J (see FIG. 1).

Outer side surface 31b of optical element 30b is a surface that is recess curved with a predetermined curvature toward the axis of the cylindrical body in a cross section that passes through the axis of the cylindrical body of optical element 30b. Optical element 30b is arranged on an optical path of light emitted from second light emitting element 13. Outer side surface 31b of optical element 30b covers second light emitting element 13 but does not cover first light emitting element 12. The main light emission direction of second light emitting element 13 is directed toward outer side surface 31b. Light emitted from second light emitting element 13 is incident onto outer side surface 31b.

As illustrated in FIG. 9, light emitted from second light emitting elements 13 diverges to transmitted light L1 that passes through outer side surface 31b of optical element 30b and reflected light L2 that is reflected by outer side surface 31b. Transparent light L1 proceeds in a direction opposite to substrate 11, and reflected light L2 proceeds in a direction opposite to lamp axis J, that is, in an outer peripheral direction of light emitting module 10D. In other words, the light distribution angle of light emitted from second light emitting elements 13 is widened by optical element 30b.

With this structure, (i) light emitted from second light emitting elements 13 and having a light distribution angle widened by optical element 30b and (ii) light emitted from first light emitting element 12 at a wide light distribution angle are superimposed with each other. As a result, uneven irradiation is reduced.

Furthermore, in light emitting module 10D, optical element 30b covers only second light emitting elements 13 and does not cover first light emitting elements 12, and thus does not substantially affect light emitted from first light emitting elements 12. In this way, it is possible to reduce decrease in light extraction efficiency of light emitting module 10D. This is because diffusion and absorption of light emitted from first light emitting elements 12 by optical element 30b can be reduced.

In addition, in light emitting module 10D, first light emitting elements 12 are arranged in a narrow area around the center of substrate 11. For this reason, it is possible to reduce the size of optical element 30b.

Optical element 30b can be made using a material and a manufacturing method similar to those used for optical element 30a. The reflectivity and transmittance of outer side surface 31b of optical element 30b can be set similarly to the case of optical element 30a.

In addition, either first spectrum light emitted from first light emitting elements 12 or second spectrum light emitted from second light emitting elements 13 can be selected as appropriate. For example, LEDs which emit red light that is first spectrum light can be used as first light emitting elements 12 that emit wide angle light, and LEDs which emit white light that is second spectrum light can be used as second light emitting elements 13 that emit narrow angle light. For example, red light can be used to accelerate growth of a plant. The light distribution angle of white light emitted from second light emitting elements 13 is widened by optical element 30b. For this reason, the white light can be used as illumination light for a worker around the plant.

### Fifth Embodiment

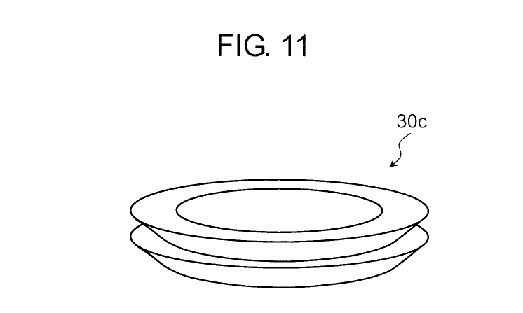

Next, a structure of light emitting module 10E according to a fifth embodiment is described with reference to FIGS. 10 and 11.

FIG. 10 is a cross sectional view in a plane that passes through a lamp axis (see FIG. 1) of light emitting module 10E.

Light emitting module 10E includes substrate 11, a plurality of first light emitting elements 12, a plurality of second light emitting elements 13, and optical element 30c. The plurality of first light emitting elements 12 are arranged circularly on substrate 11 to surround the center of substrate 11, and each emit first spectrum light at a first light distribution angle. The plurality of second light emitting elements 13 are arranged circularly on substrate 11 to surround the plurality of first light emitting elements 12, and each emit second spectrum light at a second light distribution angle. Optical element 30c is arranged on the plurality of second light emitting elements 13.

The first light distribution angle is larger than the second light distribution angle. The first light distribution angle is a wide angle, and is for example an angle ranging from 90 degrees to 120 degrees inclusive. The second light distribution angle is a narrow angle, and is for example an angle of 15 degrees or larger and smaller than 90 degrees.

Light emitting module 10E is different from light emitting module 10D in having optical element 30c arranged on second light emitting elements 13 arranged circularly.

Optical element 30c is, for example, approximately cylindrical, and has openings at both ends, similarly to optical elements 30a and 30b. The inner diameter of optical element 30c is constant, and the diameters of both openings of optical element 30c are also the same. The outer diameter of optical element 30c includes two tiers of sloped surfaces (referred to as lower sloped surface 32a, and upper sloped surface 32b) that become larger in a direction moving away from substrate 11. Optical element 30c is arranged on second light emitting elements 13 arranged circularly such that a smaller one of outer diameters of optical element 30c faces substrate 11. The axis of a cylindrical body of optical element 30c is positioned to match lamp axis J.

Part of light emitted from second light emitting elements 13 is guided inside optical element 30c, and is emitted from lower sloped surface 32a in optical element 30c in an outer peripheral direction of substrate 11. Part of light emitted from second light emitting element 13 proceeds to upper sloped surface 32b without being emitted from sloped surface 32a, is reflected by sloped surface 32b, and proceeds in an outer peripheral direction of substrate 11. However, light emitted from lower sloped surface 32a and light reflected by upper sloped surface 32b proceed in different directions.

Optical element 30c can be made using a material and a manufacturing method similar to those used for optical element 30a.

Part of light emitted from second light emitting element 13 is reflected (Fresnel reflection) or refracted by optical element 30c (see optical paths L3 in FIG. 10). In light emitting module 10E, light emitted from second light emitting element 13 having a narrow light distribution angle is changed into light of a wide light distribution angle. As a result, in light emitting module 10E, a wide light distribution characteristic that reduces uneven irradiation can be obtained.

It is to be noted that, in light emitting module 10E, second light emitting elements 13 having a narrow light distribution angle are arranged circularly to surround first light emitting elements 12 having a wide light distribution angle. As in light emitting module 10A, first light emitting elements 12 having a narrow light distribution angle may be surrounded by second light emitting elements 13 having a wide light distribution angle. With this structure, in light emitting module 10E, a wide light distribution characteristic that reduces uneven irradiation can be obtained.

In addition, either first spectrum light emitted from first light emitting elements 12 or second spectrum light emitted from second light emitting elements 13 can be arbitrarily selected. For example, LEDs which emit red light that is first spectrum light can be used as first light emitting elements 12 that emit wide angle light, and LEDs which emit white light that is second spectrum light can be used as second light emitting elements 13 that emit narrow angle light. For example, red light can be used to accelerate growth of a plant. The light distribution angle of the white light emitted from second light emitting elements 13 is widened by optical element 30c. For this reason, the white light can be used as illumination light for a worker around the plant.

Although LEDs are configured as SMD-type LEDs in the above embodiments, LEDs are not limited to the SMD-type LEDs. For example, any of the light emitting modules may be a chip-on-board (COB) type light emitting module in which bare chips are mounted directly on a substrate.

In this case, for example, wavelengths of light beams from a plurality of LED chips may be converted to predetermined wavelengths by arranging sealing members including a wavelength converting material which is for sealing the plurality of LED chips collectively or individually and containing the above-described yellow phosphor or the like.

In addition, LEDs are not required to have orientations for causing all of main emission light beams to proceed in a direction along a lamp axis, and some of the LEDs may be mounted to have orientations for causing some of the main emission light beams to proceed in a direction tilted with respect to the lamp axis. In this way, the controllability of light distribution angles in the lamp is increased, which makes it possible to make fine adjustment for obtaining preferred light distribution characteristics.

In the third to fifth embodiments, optical elements are exemplified by elements utilizing reflection and refraction on the surfaces of the optical elements, but are not limited to the exemplary elements. For example, elements obtained by dispersing light diffusing particles in a light transmitting material may be employed.

In addition, in each of the third to fifth embodiments, the structure with the optical element for widening light distribution angle of light emitted from LEDs having a narrow light distribution angle is employed as a non-limiting example. For example, an optical element for reducing a light distribution angle of emitted light may be arranged on an optical path of light emitted from LEDs having a wide light distribution angle. In this way, light emitting modules having a small light distribution angle can be realized.

In the above embodiments, light emitting modules for bulb-shaped LED lamps have been described as examples of illumination light sources, but light emitting modules are not limited to the examples having such structures. For example, the present disclosure can be applied to light emitting modules for straight-tube-shaped LED lamps.

In addition, in the above embodiments, structures using two kinds of light emitting elements of LEDs having a narrow light distribution angle and LEDs having a wide light distribution angle have been described as LEDs used in light emitting modules. However, light emitting modules are not limited to the examples having such structures. In each of the light emitting modules in the above embodiments, LEDs having a light distribution angle different from those of LEDs having a narrow light distribution angle and LEDs having a wide light distribution angle may further be arranged circularly on the substrate to surround the LEDs.

Additionally, various modifications to the embodiments and variations thereof conceivable by those skilled in the art as well as embodiments resulting from arbitrary combinations of constituent elements of the embodiment and variations thereof which do not depart from the essence of the present disclosure are intended to be included in the present disclosure.

What is claimed is:

1. A light emitting module comprising:
a substrate;
a plurality of first light emitting elements arranged circularly on the substrate, each of the plurality of first light emitting elements emitting first spectrum light at a first light distribution angle; and
a plurality of second light emitting elements arranged circularly on the substrate to surround the plurality of first light emitting elements, each of the plurality of second light emitting elements emitting second spectrum light at a second light distribution angle different from the first light distribution angle.

2. The light emitting module according to claim 1,
wherein the first light distribution angle is smaller than the second light distribution angle.

3. The light emitting module according to claim 1,
wherein the first light distribution angle is larger than the second light distribution angle.

4. The light emitting module according to claim 1,
wherein the first spectrum light and the second spectrum light are different from each other.

5. The light emitting module according to claim 1, further comprising
an optical element arranged on an optical path of light emitted from at least one of (i) the plurality of first light emitting elements or (ii) the plurality of second light emitting elements.

6. The light emitting module according to claim 5,
wherein the optical element is arranged on the substrate and surrounded by the plurality of first light emitting elements.

7. The light emitting module according to claim 5,
wherein the optical element is arranged, on the substrate, between the plurality of first light emitting elements and the plurality of second light emitting elements.

8. The light emitting module according to claim 5,
wherein the optical element is arranged on the plurality of second light emitting elements.

9. An illumination light source comprising:
the light emitting module according to claim 1;
a pedestal on which the light emitting module is mounted;
a circuit unit which supplies electric power to the light emitting module;
a cylindrical housing having a first opening and a second opening, housing the circuit unit, and having the pedestal arranged at the first opening;
a hollow globe which covers the first opening; and
a base arranged at the second opening of the housing, and electrically connected to the circuit unit.

10. A lighting apparatus comprising:
a lighting fixture including a socket; and
the illumination light source defined in claim 9 and attached to the socket.
